(19) United States
(12) Patent Application Publication
(10) Pub. No.: US 2013/0233145 A1
(43) Pub. Date: Sep. 12, 2013

(54) Laser Clad Cutting Edge for Agricultural Cutting Components

(71) Applicants: Juan G. Sotelo, Fond du lac, WI (US); Neal J. Stoffel, Campbellsport, WI (US); Keith A. Johnson, Kewaskum, WI (US); Michael A. Bechler, West Bend, WI (US)

(72) Inventors: Juan G. Sotelo, Fond du lac, WI (US); Neal J. Stoffel, Campbellsport, WI (US); Keith A. Johnson, Kewaskum, WI (US); Michael A. Bechler, West Bend, WI (US)

(73) Assignee: Kondex Corporation, Lomira, WI (US)

(21) Appl. No.: 13/787,122

(22) Filed: Mar. 6, 2013

Related U.S. Application Data
(60) Provisional application No. 61/607,220, filed on Mar. 6, 2012.

(51) Int. Cl. B21K 11/00; B26D 1/00

(52) U.S. Cl. CPC B21K 11/00; B26D 1/0006
USPC 83/835; 76/112

(57) ABSTRACT

An agricultural cutting blade has top and bottom surfaces and mounting apertures extending through top and bottom surfaces. A cutting edge support surface (e.g. that may be a flat, pointed or rounded) is formed on the cutting blade body with the cutting edge support extending along a side of the cutting blade body transversely between the top and bottom surfaces. A clad material deposited upon the cutting edge support such as by laser cladding process. The clad material can be built up, that is layered in partial or full overlapping relation to provide at least 2 and often more than 4 layers of clad material at one or more locations. A cutting edge provided by the clad material that may be a ground surface into a laser clad bead.

### CROSS-REFERENCE TO RELATED PATENT APPLICATIONS

This patent application claims the benefit of U.S. Provisional Patent Application No. 61/607,220, filed Mar. 6, 2012, the entire teachings and disclosure of which are incorporated herein by reference thereto.

### FIELD OF THE INVENTION

This invention generally relates to a laser clad cutting edge for agricultural cutting components.

### BACKGROUND OF THE INVENTION

Laser clad technology on cutting implements is known as suggested by U.S. Pat. No. 7,677,843 to Techel et al., the entire disclosure of which is hereby incorporated by reference. The present disclosure takes a much different, improved and novel approach to cutting implements, which particular application and benefit in agricultural blades (also referred to as cutting blades), but that also may be used in paper blades, forestry related blades, plastic processing blades and the like.

Other prior publication includes U.S. 2007/0163128 to Tarrerias the entire disclosure of which is also incorporated by reference. However, that is limited to applications with a single strength linear cutter edge, and not envisioned for agricultural crops such as hay, stalk or silage; such as may be used in feed mixers. A concept for feed mixers is shown in U.S. Pat. No. 5,823,449, however, that relies upon brazing on solid carbide.

### BRIEF SUMMARY OF THE INVENTION

This invention is to aid in the prevention of premature wear and dulling to the cutting edge of agricultural blades. The design being proposed will reduce the wear of the cutting edge most commonly caused by the continuous cutting of crops or other commodities. Also, another major factor in the premature dulling of the blade that this invention will help prevent is chipping from foreign materials such as rocks, stones, or ice contacting the blade edge causing damage to the blade edge reducing the blades ability to cut effectively. A further benefit of this invention is the prevention of erosion of the cutting blade body at the base of the cladding.

One aspect of the present invention is directed toward a method of providing a cutting blade that includes cladding at least two layers of clad material upon a cutting edge support surface. The method includes providing a cutting blade with a cutting blade body having first and second side surfaces, the cutting blade body being formed of a first material such as steel. A cutting edge support surface is formed along the cutting blade body. The cutting edge support surface extends along an end surface of the cutting blade body transversely between the first and second side surfaces. The method further includes cladding at least two layers upon the cutting edge support surface to form a tip of a second material that provides at least one of a greater hardness and wear resistance relative to the first material. For example, the second material may include at least one of the following, tungston carbide, titanium carbide, chrome carbide, iron carbide, diamond, ceramic or other material having a Vickers scale hardness between HV 1200-2500. Thereafter, the tip may be sharpened to form a cutting edge in the second material.

Another inventive aspect of the present invention is directed to a method comprising laser cladding clad material onto a cutting edge support surface at two different locations, which may comprise approaches from alternating sides of the cutting blade body, or otherwise in different locations such as on top of each other and/or at discrete locations. The method includes providing a cutting blade with a cutting blade body having first and second side surfaces. The cutting blade body is formed from a first material and has a cutting edge support formed thereon. The cutting edge support surface extends along an end surface of the cutting blade body transversely between the first and second side surfaces. The method further includes laser cladding at a first location, a second material upon the cutting edge support surface. The second material that provides at least one of a greater hardness and wear resistance relative to the first base material of the cutting blade. Further, the method envisions laser cladding at a second location, the second material on the cutting edge support surface. Finally, the method may include sharpening at least one cutting edge into the second material.

Certain aspects of the present invention are also directed toward the apparatus. For example, one aspect is directing toward a cutting blade comprising a cutting blade body having first and second side surfaces and mounting apertures extending through the first and second side surfaces. The cutting edge support surface is formed on the cutting blade body. The cutting edge support surface extends along a side of the cutting blade body transversely between the first and second side surfaces. The clad material is deposited upon the cutting edge support surface. The cutting edge is provided by the clad material in which the cutting edge comprises at least one of a plurality of discrete edge segments and at least one non-linear edge.

Another aspect of the present invention is directed toward a cutting blade comprising a cutting blade body having first and second side surfaces and mounting apertures extending through the first and second side surfaces. A cutting edge support surface is formed on the cutting blade body that extends along an end surface of the cutting blade body transversely between the first and second side surfaces. The clad material build up is provided comprising a plurality of layers including a first layer that is depositing upon the cutting edge support surface and a second layer that is at least partially overlapping the first layer. For example, the second layer may be placed side by side with the first layer in contact and/or on top of the first layer in full or partial overlap. A cutting edge is provided by the clad material.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view of an augur knife (also referred to as “mixer blade”) having a plurality of laser clad cutting edges formed thereon in accordance with a first embodiment of the present invention;

FIG. 2 is a side view of the auger knife shown in FIG. 1;

FIG. 3 is a cross section view taken about A-A in FIG. 1;

FIG. 4 is an enlarged detail view taken about circle B in FIG. 3, shown in partial schematic shown before and after sharpening with the portion that is being ground off during sharpening being shown as well as lines indicating profile after sharpening;

FIG. 5 is a top view of a clock-wise knife (also referred to as “crop cutting blade”) having a laser clad cutting edge in accordance with a second embodiment of the present invention;

FIG. 6 is a front side view of the blade shown in FIG. 5;

FIG. 7 is a right hand side view of the blade shown in FIG. 5;

FIG. 8 is an enlarged detail view of a portion of the knife taken about circle A in FIG. 7;

FIG. 9 is a top view of an alternative embodiment of a mixer blade similar to the first embodiment of FIG. 1, but employing different laser cladding;

FIG. 10 is a side view of the mixer blade shown in FIG. 9;

FIG. 11 is a cross-section taken about section A-A in FIG. 9;

FIG. 12 is a top view of an mixer blade similar to FIGS. 1 and 9, but employing yet a further alternative embodiment of the present invention with a different cutting edge support surface and laser cladding profile;

FIG. 13 is a side view of the blade shown in FIG. 12;

FIG. 14 is a cross-section taken about section A-A in FIG. 12;

FIGS. 15 and 16 are side elevation and top views of a feed mixer employing the mixer blade of any of embodiments of the auger knife discussed above;

FIGS. 17 and 18 are embodiments of drum mowers and disc mowers shown in prospective views, which include the blade utilized in the embodiment of FIGS. 5-7;

FIGS. 19a-19g are a progression of perspective and partially schematic views of laser cladding adhesive buildup upon a blade edge in accordance with an embodiment of the present invention and that may be used with any of the embodiments discussed above; and

FIG. 20 is another cross section and partly schematic view of methodology for laying multiple laser clad beads upon the cutting edge support surface in accordance with a further embodiment of the present invention, with dashed lines illustrating the outline before sharpening and solid lines showing after sharpening.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the recent invention are designed to improve the surface properties related to the wear characteristics of metals used to manufacture agricultural cutting blades. This design specifically targets the cutting edge of agricultural blades and replaces that edge by building an edge on the blade using hard/wear resistant materials deposited using laser cladding technology.

It is common in today's industry to apply hard coatings on the top of or behind the cutting edge of the blade/knife. Also, it is common to see inserts brazed onto the cutting edge of the blade. Embodiments of the present invention differ from these already common concepts by using laser cladding technology to create the actual cutting edge of the knife and not to support an existing edge.

The hard/wear resistant laser clad material being referred to in various embodiments of the invention is material composed of a medium to high percentage of hard particles. These hard particles can be: Tungsten Carbide, Titanium Carbide, Chrome Carbide, Iron Carbide, Diamond, Ceramics, or any other high hardness particles in the range of HV 1200-2500 (Vickers scale hardness). The high hardness particles are then bonded and held in place by a base material composed of various metal alloys.

Laser cladding is the process of cladding material with the desired properties and fusing it onto the substrate by means of a laser beam. Laser cladding can yield surface layers that when compared to other hard facing techniques or standard blade material can have superior properties in terms of hardness, bonding, corrosion resistance and microstructure.

The design being introduced is to create a surface on the existing blade where an amount of laser cladding can be targeted and built up (e.g. as separate stacked layers and/or at different locations and/or approaches) to form a blunt bead of laser cladding along an edge that will become the cutting edge of the blade. Once the laser cladding material has been applied to the desired surface a second operation can be performed to create a sharp cutting edge. This secondary sharpening operation would include but not be limited to machining, grinding, and lapping.

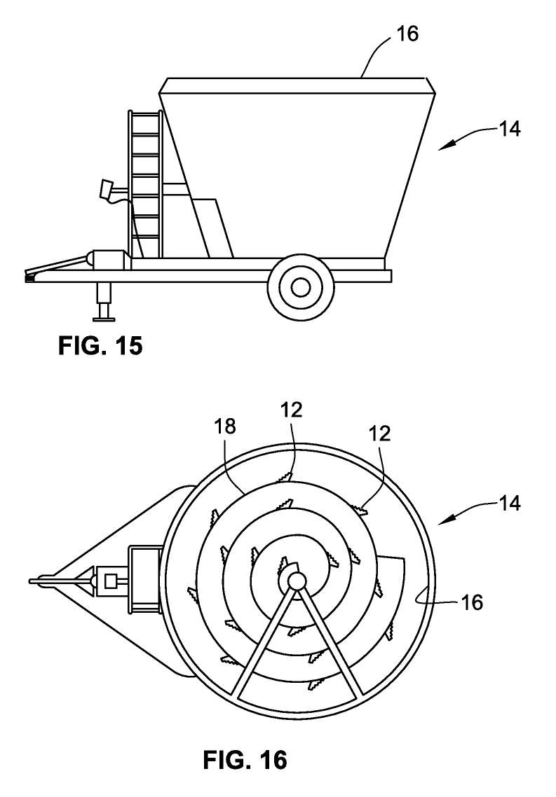

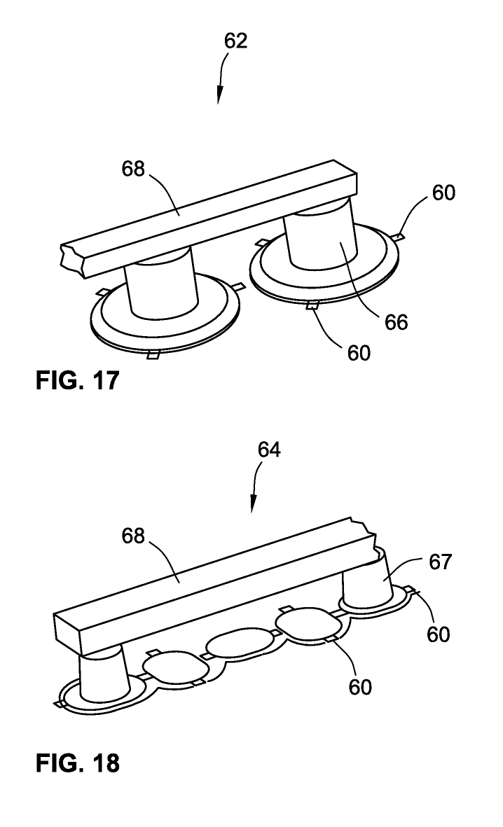

One embodiment for this invention is a laser clad cutting edge 10 on a mixer blade 12 used in an agricultural feed mixer 14. As shown in FIGS. 15-16, these feed mixers 14 are large heavy duty steel constructed chambers used to mix bales of hay, long roughage and other commodities. Inside these chambers 16 are large augers 18 with steel blades attached to each auger. The auger design along with the blade profile and pattern come in a variety of configurations and options depending on the feed mixer. The main purpose of the mixer blades 12 is to continuously and efficiently cut while also mixing the selected commodity. For these blades to perform at a high level they need to hold a cutting edge that allows for the cutting/mixing process to take place.

This use of laser cladding build up 20 to create the cutting edge 10 greatly aids in the blades 12 effectiveness to perform under multiple circumstances for longer periods of time. Using laser cladding as a way to create the cutting edge 10 has multiple key advantages in this application. First, due to the increased surface properties of the cutting edge the blade will hold its sharpness for a longer period of time. This in turn prevents the blade from being re-sharpened or replaced as often as a standard mixer blade. Second, with the improved properties of the blade edge the mixer does not require as much torque to cut and mix resulting in less horsepower used to run the equipment. With less horsepower being consumed by the mixer this will ultimately save the operator money in fuel consumption. Lastly, another key element in using laser cladding to create the blade edge is the bonding characteristics of the laser cladding process. This helps prevent any chipping of material or insert breakage commonly seen with current inserted mixer blades on the market today. The style of mixer blade that uses brazed inserts as its cutting edge can be susceptible to the insert breaking off from the blade body and entering the mix. This leaves the cattle or livestock vulnerable to consuming and digesting these foreign objects that were introduced to their feed.

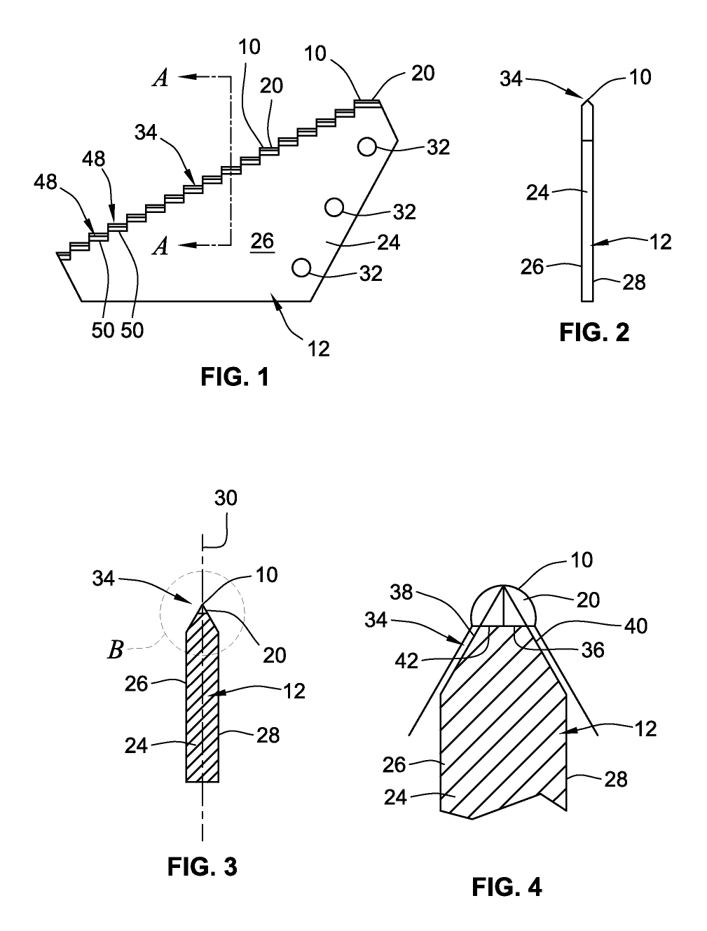

Turning in greater detail to the cutting blade, which is shown as a mixer blade 12 in FIGS. 1-4, it can be seen that it is provided with a cutting blade body 24. The cutting blade body 24 includes opposite top and bottom side surfaces 26, 28 that generally define and/or are aligned generally parallel with each other and the main plane 30 of the overall body 24. The cutting blade body 24 may be formed of stock steel material and formed as a blank created from sheet or plate stock material. Three specifically arranged and aligned mounting holes 32 are provided, which correspond to mounting studs (e.g. mounting studs having this corresponding pattern and alignment and spacing) on the agricultural feed mixer 14 shown in other figures (see e.g. FIGS. 15 and 16).

The cutting blade body is provided at its periphery end surface 34 with a cutting edge support surface 36 upon which the laser cladding buildup 20 can be built. The periphery end surface 34 generally extends transverse and typically perpendicular between the top side surface 26 and bottom side surface 28. It should be noted that the cutting edge support surface can include first and second converging surfaces that are joined at an end tip 42, which in this case is a flat surface bridging the distance between the converging surfaces 38, 40. In this embodiment, each converging surface 38, 40 projects from the top side surface 26 and bottom side surface 28, respectively, at oblique angles. Thus, the converging surfaces generally extend toward the other side surface. It is also envisioned, however, that one of the converging surfaces may simply be a portion top or bottom side surfaces 26, 28 generally at the proximity of the cutting edge 10 and at the location of the peripheral end surface 34. In this alternative embodiment, there might be one converging edge at an oblique angle that extend toward the other side surface and a corresponding span along the main plane of which would be and provide for the second converging surface provided by the end portion of one of the top or bottom side surfaces 26, 28.

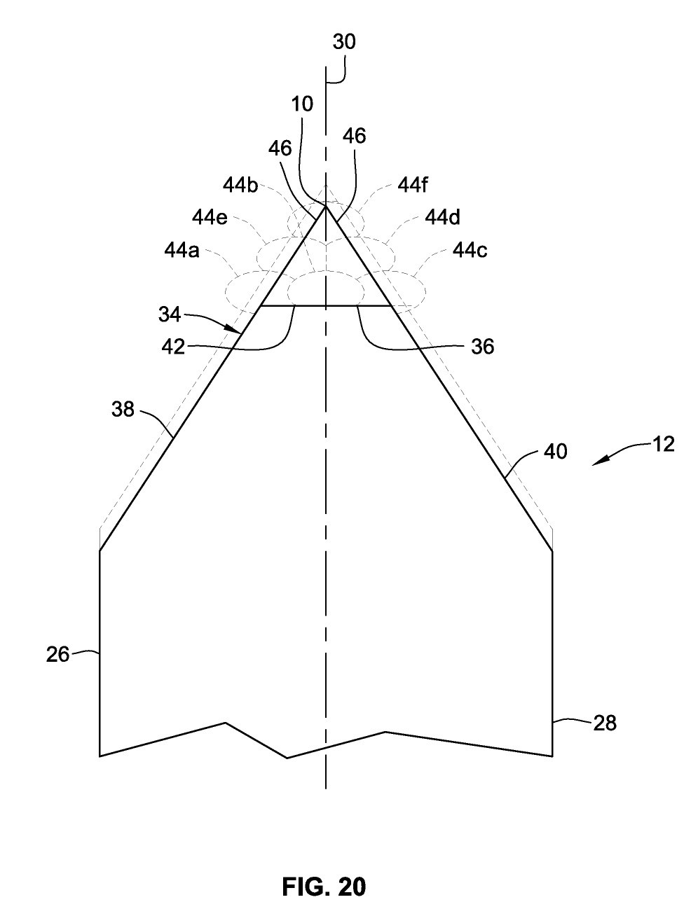

To provide for the laser clad cutting edge 10, first, laser cladding is built up upon the cutting edge support surface 36 to provide laser cladding buildup 20, which may comprise several layers 44a-f of laser cladding in overlap as shown in FIG. 20. The length of each layer (also may be referred to as a bead) is laid longitudinally and thereby run along the cutting edge generally parallel thereto. By generally parallel, it is meant parallel or about parallel (for example less than 20 degrees difference). Layers are laid to the base steel blade material side by side overlapping each other at adjacent sides to cover the base metal material, and layers are also built on top of earlier laid layers that do not touch the base metal and are laser clad layers in overlap in complete overlapping relation. As shown in this embodiment, 2 or more, typically at least four layers and as shown, six layers in an embodiment, which are built up upon each other by virtue of multiple passes of a laser cladding tool over the different adjacent side by side locations and/or over the top at the same location as shown in this embodiment or alternatively other in different locations and/or from different approaches as shown in other embodiments discussed herein.

As shown in this embodiment, the laser cladding buildup 20 is generally confined to the flat end tip 42, but it may also overlap and extend upon the first and second converging surfaces 38, 40. By extending over the converging surfaces as shown in other embodiments, an advantage is gained during use in agricultural applications in that erosion of the base steel substrate material is prevented or minimized along the converging sides during use and contact with agricultural stalk and crop material, especially at the interface between the cladding material and the base steel material.

After the laser cladding buildup 20 is provided with multiple layers 44 built upon each other in side by side relation and/or on top of each other, then sharpening of the buildup material may be conducted such as by a grinder or other operation to remove material along opposed side of the laser cladding buildup 20 to create converging flanks that meet at a sharpened tip, which forms the laser clad cutting edge 10. In some embodiments, the flanks at the base or intersection where the laser cladding buildup is joined to the end tip, the flanks may create a wider span in cross section as compared with the span of the end tip 42. As a result, any laser clad material remaining on the first or second converging surfaces 38, 40 may remain such that the laser clad material forms an enlarged sharpened head overlaid upon the end tip 42 and where the laser cladding material ends, a reduced neck region may be formed. Alternatively, the material may be removed and sharpened down to the same profile as the existing converging surfaces 38, 40 on the preformed blank or may be ground even further to reduce converging surfaces 38 and 40 further.

Typically, and for different embodiments discussed herein, the end tip 42 may span between 0 and 0.2 inches. The flank length of each converging flank 46 may be between 0.1 and 0.5 inches. Typically, the laser clad buildup from the terminating apex of the end tip 42 to the outer most extent of the laser clad buildup (e.g. a maximum thickness measured perpendicular to main plane of the laser cladding material may be between 0.05 and 0.3 inches). Individual bead layers may be laid with a thickness between ¼-3 millimeters and a width between 1 millimeter and 5 millimeters typically (although other machines may lay beads thicker and up to ¾ inch wide). The length of any individual layer will depend and typically correspond to the corresponding length of the cutting edge may between ½ inch and 20 inches long. Typically the bead will run a length at least 5 times as long as it is wide. These parameters may apply to any embodiment discussed herein.

Another feature that is provided as well as inventive aspect is the provision for laying the laser cladding at more than one location on the cutting blade body 24. For example, the cutting blade body is provided with multiple teeth arranged along the outer peripheral end surface 34, which provide different cutting edge segments 50 that make up the laser clad cutting edge 10. Thus, the laser cladding is not limited to one location, but can be applied at multiple locations in this manner as well.

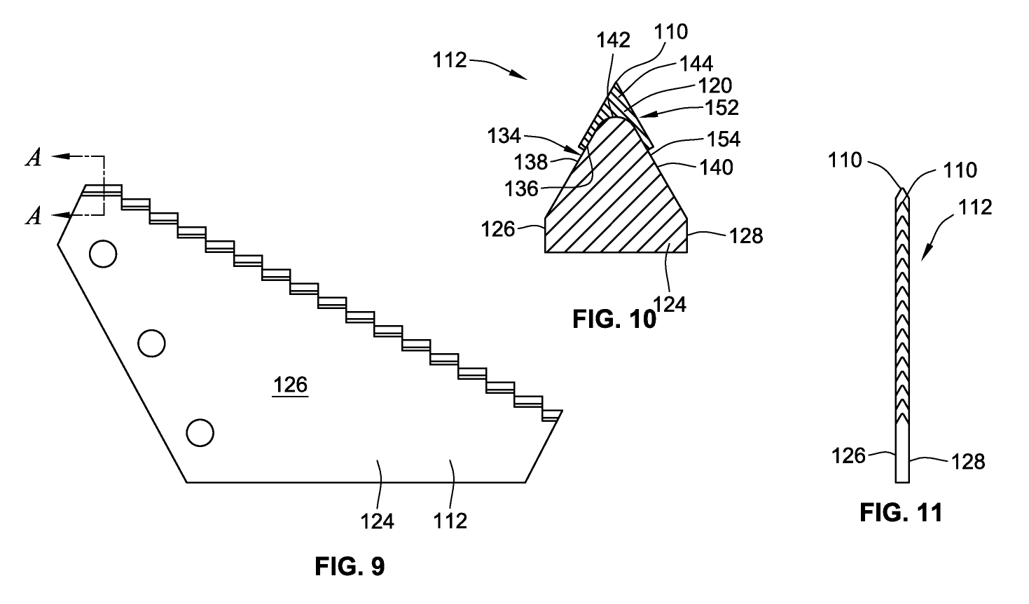

Turning to FIGS. 9-11, an alternative embodiment of a mixer blade 112 is illustrated that is similar in all respects to mixer blade 12 and includes the same structures and features except for as otherwise described herein as it relates to how the laser cladding buildup 120 is provided as well as the configuration of the peripheral end surface 134 and end tip 142. As shown in this embodiment, the first and second converging surfaces 138, 140 are joined by the rounded end tip 142 upon which the laser cladding buildup 120 is applied.

In this embodiment, one and preferably at least two more layers are applied to the first converging surface 138 and likewise, one and preferably two or more layers are also applied to the second converging surface 140 all in at least partial overlapping relation. The layers 144 on the first converging surface overlap each other and partially overlap those applied to the second converging surface and likewise, those applied to the second converging surface overlap each other and partially overlap those applied to the first converging surface to overall provide the laser cladding buildup 120 that extends over the end tip 142. As can be seen, clad material is built up over the end tip 142 as well as along the converging surfaces 138, 140.

Further, this embodiment provides an enlarged head 152 as a result of the laser clad buildup 120 that extends beyond the extents of converging surfaces 138, 140. As a result, a reduced neck 154 is formed behind the laser clad buildup. The reduced neck provides protection to the base steel material of the cutting blade body preventing erosion to the base steel material whereat the clad material is deposited and fused. To provide for this finished product, the sharpening of only some of the buildup 120 that may be less than one layer thick of removal or between 1-2 layers thick). As a result, the second material remains built up and overlapping relation along at least one of the converging surfaces and typically, both converging surfaces 138, 140. None of the base support material (e.g. steel) of the cutting blade body may be removed in some embodiments after cladding operations. This provides a thickened region proximate the cutting edge that is thicker in cross section then the cutting edge support surface 136 (according to the cross section shown in FIG. 10, which is taken through a plain extending through each of the side surfaces and generally perpendicular to the cutting edge).

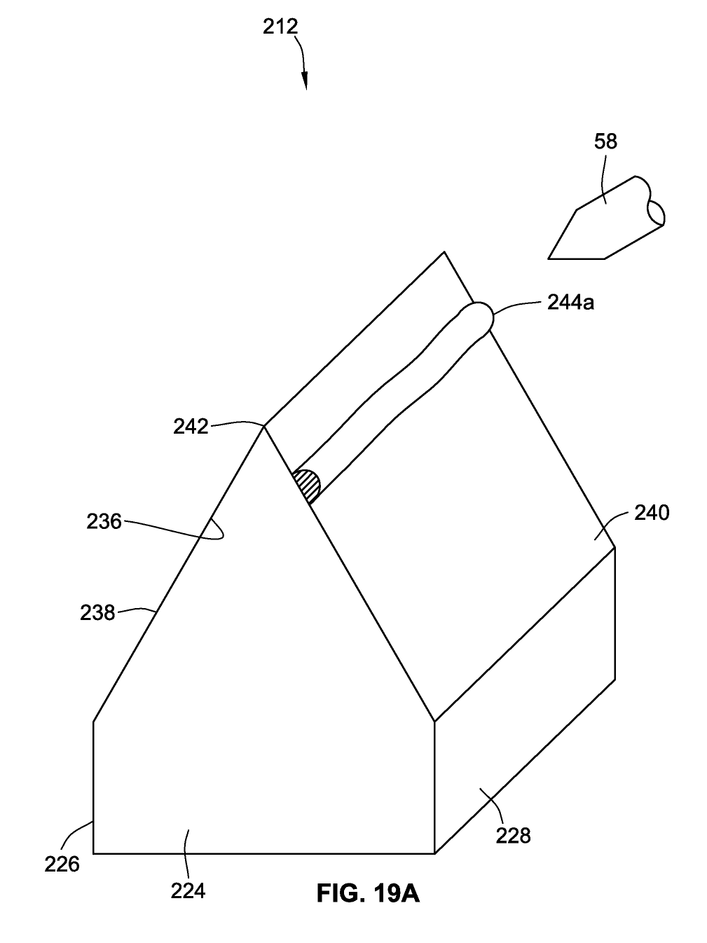

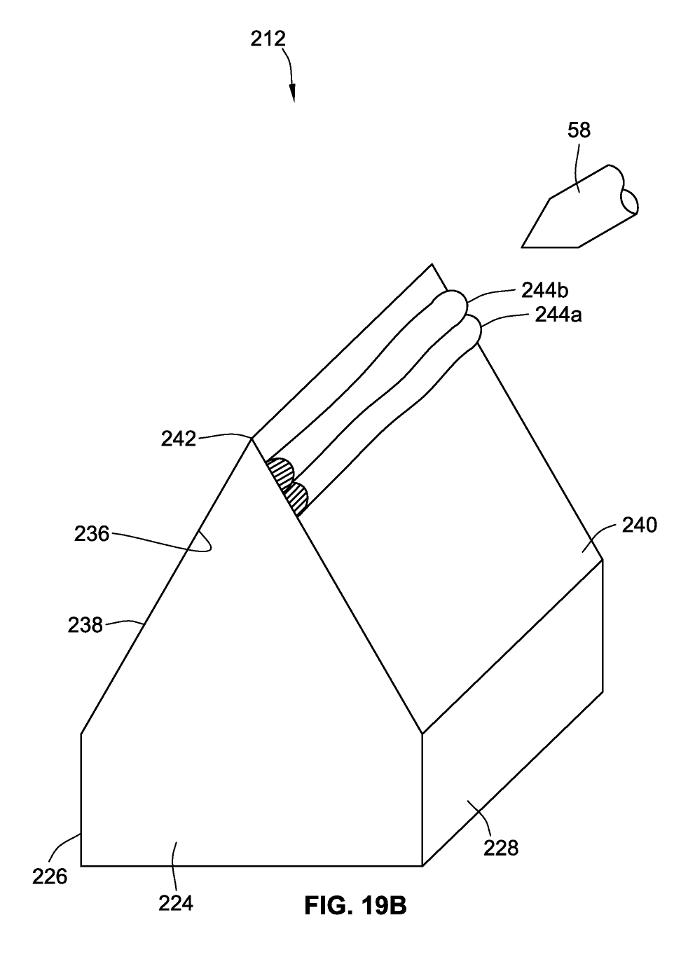

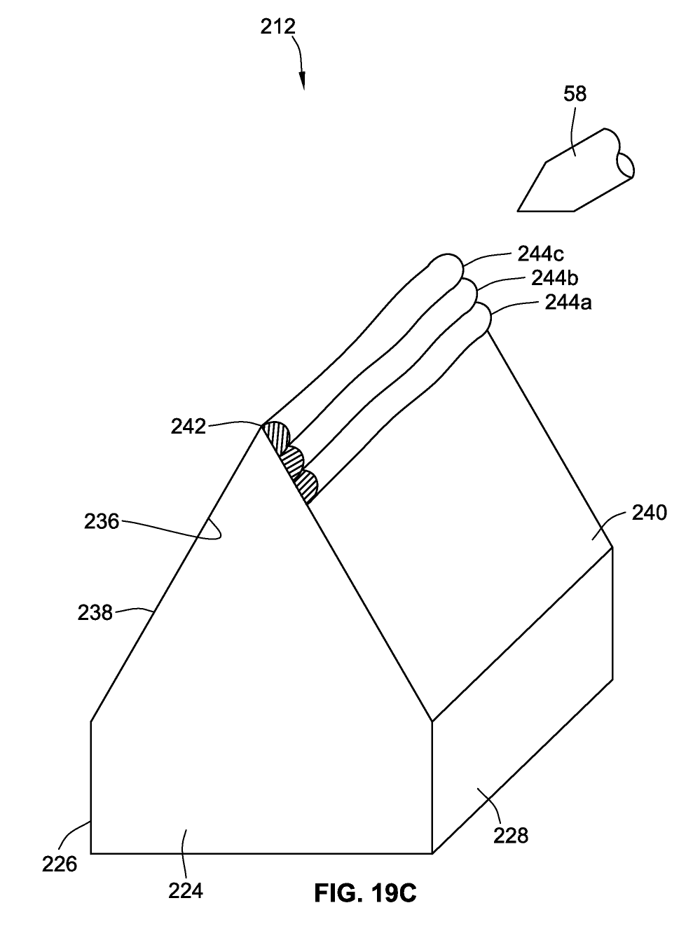

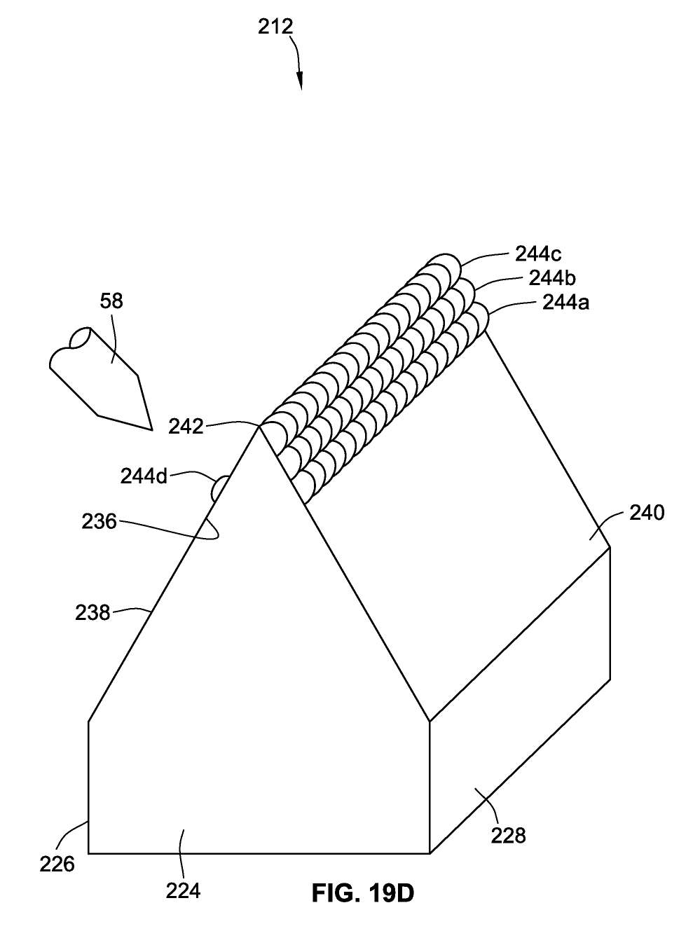

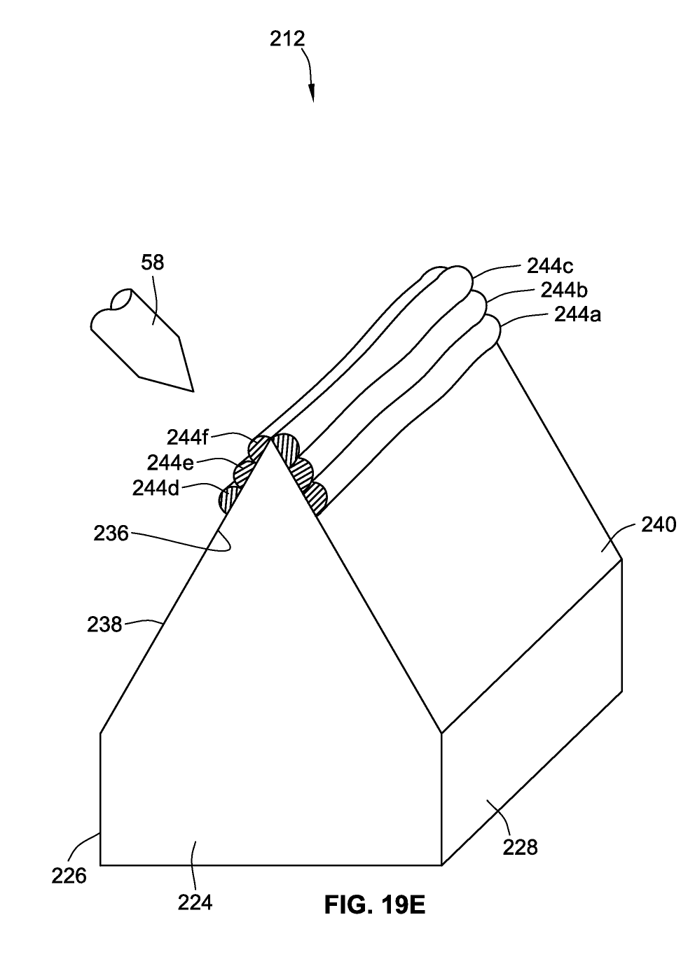

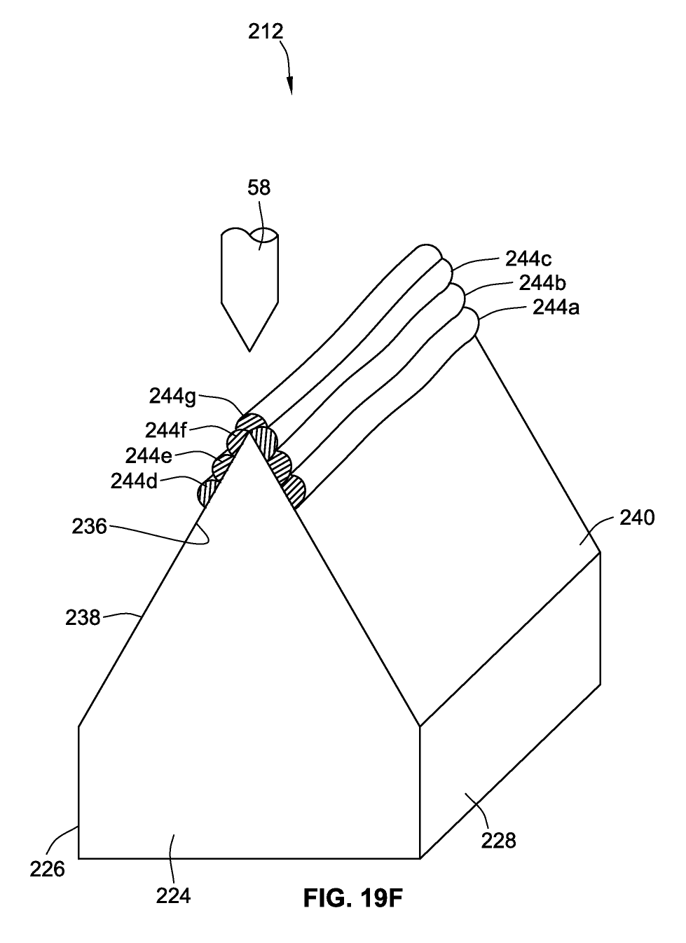

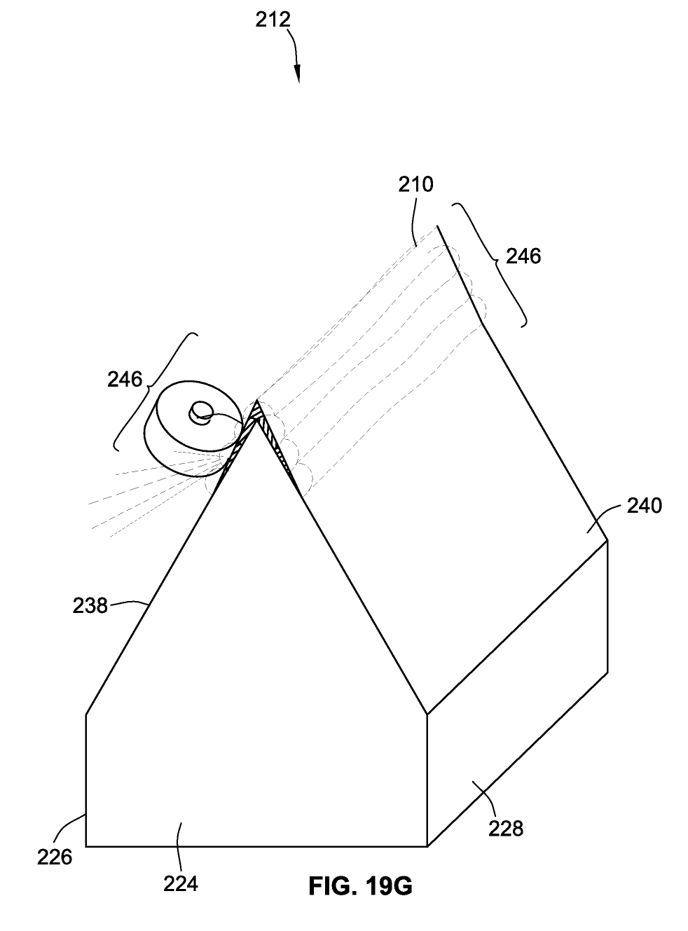

Further, and as will be described in the next embodiment and as shown in FIGS. 19a-19g, cladding with multiple layers 144 is accomplished with different approaches to the cutting blade body 124 with at least a first approach that is long and from the top side surface 126 and a second different approach that is at least partially from and along the bottom side surface 128.

Otherwise, the other additional features including laying at multiple locations upon teeth and the provision for mounting holes to enable use with the agricultural feed mixer 14 is also provided in this embodiment.

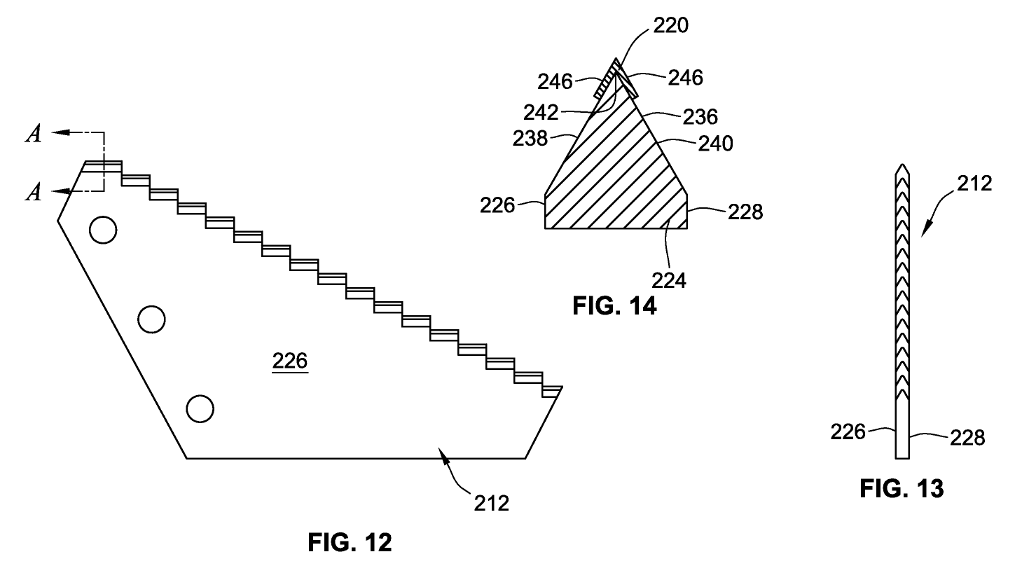

Turning now to FIGS. 12-14, yet a further embodiment of the present invention is provided, which is similar to the last embodiment of the mixer blade 112, however, in this embodiment, the cutting blade body 224 include first and second converging surfaces 238, 240 that are adjoined at a sharpened end tip 242 (as opposed to rounded end tip 142 or flattened end tip 42 in previous embodiments). The sharpened end tip 242 provides along with the converging surfaces 238, 240 the cutting edge support surface 236. Likewise, the laser cladding buildup 220 is formed along the converging surfaces 238, 240 like the previous embodiment.

Turning to additional FIGS. 19a-19f, a progression of forming different layers 244 a-g on opposing sides of the converging surfaces 238, 240 is shown with different approaches of a laser clad tool 58 that approach the cutting blade body 224 alternatively from a top side surface 226 and bottom side surface 228 in alternating fashion to form layers 244 a-g as shown in this embodiment. It will be appreciated that more or less layers may be formed, but generally at least four layers are performed in most embodiments.

Further, it can be seen that the layers partially overlap each other with the layers on opposing sides overlapping partially at the end tip 242 and with layers on the same sides overlapping each other in substantially complete relation to sandwich intermediate layers therebetween. As can be seen each layer 244a-g is laid in a different location and spacing from the end tip, with adjacent layers in contact and thereby partial overlap. This overall, provides for a laser clad buildup 220 on the cutting edge support surface 236, which may be sharpened as shown in FIG. 19g by way of a grinding which removes material on each side of the laser cladding buildup 220 to create converging flanks 246. This provides, when sharpened, an overall laser clad cutting edge 210 which can then be used for the agricultural feed mixer 14 as shown in other figures. Preferably, prior to sharpening and after all of the layers 244 a-g are built up upon the cutting edge support surface 236, a heat treatment may be performed to harden and temper the combination of the steel cutting blade body and the laser clad buildup. Thereafter, it can be sharpened to form the cutting edge to form a sharpened edge.

As to application of individual layers 244 a-g (or the other layer 144 or 44 A-F in prior embodiments see also FIG. 20), the teachings and disclosure of U.S. Pat. No. 8,096,221 to Tarrerias or U.S. Pat. No. 7,677,843 to Techel et al. may be applied including any of the materials and additional treatment indicated in those disclosures.

It should be noted that any of the parameters and discussion of one of the embodiments is generally applicable to the parameters and may be applied and equally pertains to the disclosure of other embodiments in this application.

Embodiments of the invention also relate to the crop cutting blades 60 of a machine for severing standing crops from the ground to initiate a harvest process, and more particularly to an agricultural mower (such as drum mower 62 or disc mower 64) incorporating a rotary disc-cutter bar 68. The rotary disc cutter-bar 68 is made up of a number of transversely oriented cutter modules having rotatable discs 66 or 67 and carrying the cutting blades 60 to sever standing crop by impact. The cut crop is then conveyed to a conditioning mechanism before being discharged to the ground for drying and subsequent harvesting.

In the use of these mowing machines, the cutting blades are subjected to extremely abrasive wear conditions, and the wear is usually concentrated to the edge and subsequently the tip of the cutting blade causing this blade edge and knife tip to become rounded and dull. As the blade edge and tip continue to wear in this manner, the stalks of the crop being cut tend to slide around the outer edge of the cutting blades, causing a number of major problems. This continuous sliding effect multiplies and accelerates the wear on the cutting edge and tip of the cutting blade. The stalks of the crop slide off of the cutting blades instead of being cut. Stalks of the plant material can also be very abrasive themselves, so one would expect that if the stalk is cut upon impact it doesn't slide, thus it doesn't exacerbate the wear on the edge and tip of the cutting blade.

In addition to the excessive cutting blade wear this sliding effect causes, it also stands to reason that if the individual stalks of plant material are sliding off the end and not being cut on every rotation of the disc 66, there is a cutting efficiency loss. The plant material continues to be pushed forward in the direction of machine travel. Eventually the plant stalk material overcomes the pushing force because of the stalk being anchored in the ground, and is severed by the blade on the very tip that is the most dull. Consequently, two very important considerations are impacted by this effect. One, there is a desire in this process to have a clean cut which is of a consistent height from ground level. This helps in the re-growth effort of the crop being grown. In this case, both of those desires will not be met. Two, because of the fact that a large percentage of the crop stalks are being severed by the dullest part of the cutting blade, it takes a much greater force to keep the discs rotating at the desired velocity. This equates to higher horse power requirements and increased fuel usage which is one of the main components in the cost of performing this process.

An embodiment invention of using laser cladding 70 to create the cutting edge 72 of this blade 60 has several benefits. First, because of laser claddings increased surface properties the edge of these blades would be more resistant to wear. Allowing these blades to cut on contact for a longer period of time and preventing the excessive tip wear seen on standard blades. Secondly, because of the previously stated advantage these blades wouldn't need to be replaced by the operator as often. Lastly, because of the characteristics of laser cladding these parts will be more resistant to chipping and deformation compared to other hard coated parts on the market today.

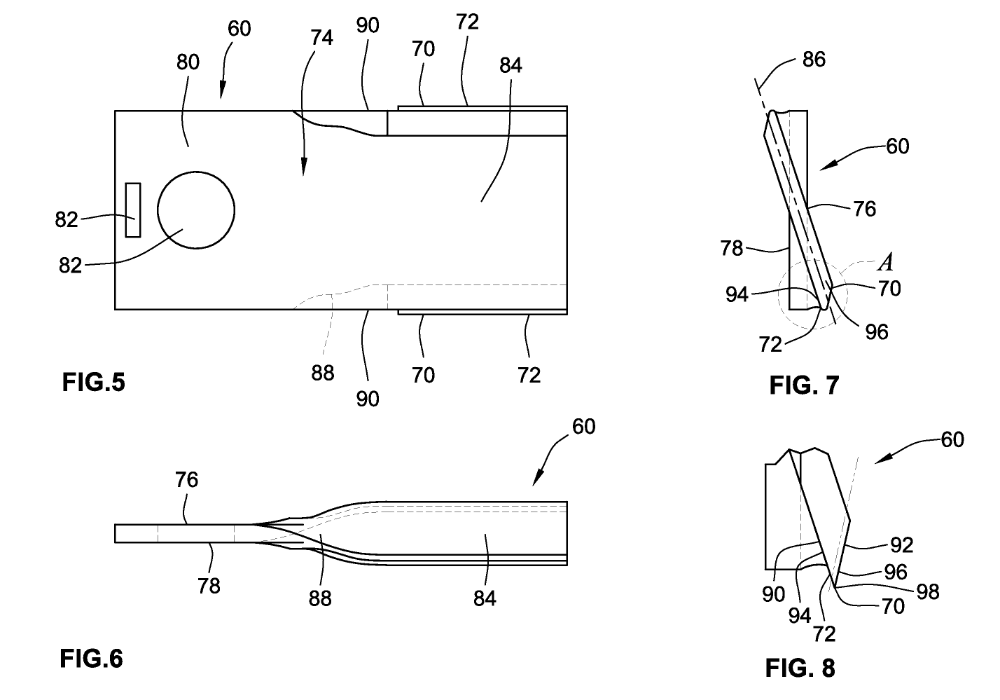

Turning in greater detail to the crop cutting blade 60, it can be seen from FIGS. 5-8 that it is provided with a cutting blade body 74 having opposed top and bottom side surfaces 76, 78. The cutting blade body 74 includes a base section that includes mounting apertures 82 for securing the cutting blade 60 to one of the mowers 62, 64, as well as a cutting wing section that define a main plane 86. As can be seen, the cutting wing section is angularly offset from the base section through deformation of a transition section 88. These particular blades are reversible to include different locations where laser cladding 70 is applied along the peripheral end surface and that can provide two sections of a cutting edge support surface 92. At each section of the cutting edge support surface 92, a first converging surface 94 and a second converging surface 96 are provided, which are joined at an end tip 98, which may be one of rounded, flat or pointed, each of which has different features and advantages. The laser cladding 70 can be built up in several layers upon the cutting edge support surface 92 at the different sections or location in any of the ways previously mentioned for the first three embodiments as applied to the mixer blade described above, such as shown in FIGS. 19a-19f and/or FIG. 20.

In this embodiment, it can also be seen that one of the converging surfaces 94 can be part of the top or bottom surfaces, that is the portion at the peripheral end surface 90 where converging towards the end tip 98 takes place.

In this embodiment, it is shown that the laser cladding is merely situated on the end tip 98 and does not extend over either of the converging surfaces 94, 96. However, as per prior embodiments, and as shown schematically in relation to FIGS. 19a-19g, laser cladding can be done over the converging surfaces as well as the end tip to provide an increased head region at this location. Likewise, the laser cladding 70 is ground sharp to provide the cutting edge 72 formed into the laser clad 70, which is built up upon the cutting edge support surface 92.

The Feed Mixer blades and Disc Mower blades are just a few examples of cutting blades this invention would be applicable on and the advantages of using laser cladding technology for the cutting edge for these blades. Other cutting blades this invention would be applicable on but not limited to are: Straw chopper blades, Sugar Cane blades, & Forage Harvestor blades. All these blades are common in the agricultural industry and would benefit from the advantages of this invention in similar ways as stated from the two previous examples (Feed Mixers & DMK blades). These other applications are covered herein. Based on the foregoing, it is recognized that one or more of the following potential advantages and novel features or advantages may be realized according to different embodiments below:
a) Using laser cladding to create a cutting edge would give the blade edge superior hardness preventing wear.
b) Laser cladding creates a strong bond with the substrate preventing chipping of laser clad material and improving blade life.
c) Laser cladding provides good corrosion resistance improving the life of the blade edge.
d) Laser cladding can be configured to match existing part dimensions; this allows for parts to be a direct replacement for existing blades.
e) There is a wide range of options when choosing laser cladding material which makes laser cladding a very unique and versatile process that can be used for a variety of different applications.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method, comprising:
providing a cutting blade with a cutting blade body having first and second side surfaces, the cutting blade body being formed of a first material, a cutting edge support surface formed on the cutting blade body, the cutting edge support surface extending along an end surface of the cutting blade body transversely between the first and second side surfaces;
cladding at least 2 layers upon the cutting edge support surface to form a tip of a second material that provides at least one of greater hardness and wear resistance relative to the first material, a cutting edge provided in the second material.

2. The method of claim 1, wherein the cutting edge support surface comprises first and second converging surfaces, the first converging surface extending from the first side surface at an oblique angle toward the second side surface, the first and second converging surfaces being joined by an end tip.

3. The method of claim 2, wherein at least one of the layers is laid upon each of the first converging surface and the second converging surface.

4. The method of claim 3, wherein the end tip is one of rounded and pointed.

5. The method of claim 3, wherein the end tip is flat.

6. The method of claim 2, wherein said cladding includes building up the second material along at least one of the converging surfaces.

7. The method of claim 6, and wherein during sharpening only some of the built up second material is removed after sharpening along said at least one of the converging surfaces, the second material remains built up in overlapping relation along said at least one of the converging surfaces to provide a thickened region proximate the cutting edge that is thicker in a cross section than the cutting edge support surface, the cross section in a plane extending through each of the side surfaces and perpendicular to the cutting edge.

8. The method of claim 7, wherein said cladding includes building up the second material along both of the converging surfaces and that at least partially remains after sharpening, wherein a step in profile along the converging surfaces is defined and created by the built up second material along the converging surfaces.

9. The method of claim 1, further comprising, cladding the at least two layers with different approaches cutting blade body including cladding with a laser clad approach that is at least partially from and along the first side surface and cladding with a laser clad approach that is at least partially from and along the second side surface.

10. The method of claim 9, wherein the second material includes at least one of the materials comprising: tungsten carbide, titanium carbide, chrome carbide, iron carbide, diamond, ceramic, and other material having a Vickers scale hardness between HV 1200-2500.

11. The method of claim 1, wherein the cladding comprises fusing the second material with a laser beam.

12. The method of claim 1, further comprising, configuring the cutting blade as an agricultural cutting blade with mounting apertures corresponding to mounting structure on an agricultural implement that is one of a feed mixer, a mower, stalk chopper and a harvester.

13. The method of claim 1, wherein the at least two layers comprise at least 4 layers built and thereby at least partially clad upon each other.

14. The method of claim 13, wherein at least one layer of the second material is sandwiched between two layers of the second material.

15. The method of claim 1, further comprising sharpening the tip to form the cutting edge that is sharp into the second material.

16. The method of claim 1, wherein at least some of the layers are laid longitudinally running in a same direction as the cutting edge in side by side relation and in partial overlapping relation.

17. A method comprising:
providing a cutting blade with a cutting blade body having first and second side surfaces, the cutting blade body being formed of a first material, a cutting edge support surface formed on the cutting blade body, the cutting edge support surface extending along an end surface of the cutting blade body transversely between the first and second side surfaces;
laser cladding at a first location a second material upon the cutting edge support surface, the second material providing at least one of greater hardness and wear resistance relative to the first material,
laser cladding at a second location the second material upon the cutting edge support surface, the cutting edge being provided in the second material.

18. The method of claim 17, wherein the first and second locations are spaced and discrete forming disconnected different cutting edge segments for the at least one cutting edge.

19. The method of claim 18, wherein the first and second locations are built upon each other, with the first location being along the end surface and the second location at least partially overlapping the first location.

20. The method of claim 19, further comprising using different approaches to cutting blade body for cladding including cladding with a laser clad approach that is at least partially from and along the first side surface and cladding with a laser clad approach that is at least partially from and along the second side surface.

21. The method of claim 17, further comprising configuring the cutting blade as an agricultural cutting blade with mounting apertures corresponding to mounting structure on an agricultural implement that is one of a feed mixer, a mower, stalk chopper and a harvester.

22. The method of claim 17, wherein the second material includes at least one of the materials comprising: tungsten carbide, titanium carbide, chrome carbide, iron carbide, diamond, ceramic, and other material having a Vickers scale hardness between HV 1200-2500.

23. The method of claim 17 further comprising sharpening at least one cutting edge into the second material.

25. The method of claim 17, wherein the different locations comprise at least two layers that are laid longitudinally running in a same direction as the cutting edge in side by side relation and in partial overlapping relation.

26. A cutting blade, comprising:
a cutting blade body having first and second side surfaces and mounting apertures extending through first and second side surfaces;
a cutting edge support surface formed on the cutting blade body, the cutting edge support surface extending along an end surface of the cutting blade body transversely between the first and second side surfaces;
a clad material deposited upon the cutting edge support surface; and
a cutting edge provided by the clad material, the cutting edge comprising at least one of a plurality of discrete edge segments and at least one non-linear edge.

27. The cutting blade of claim 26, wherein the clad material comprises laser clad bead laid upon the cutting edge support surface in a direction of the length of the cutting edge, the laser clad bead being ground to a sharpened tip.

28. A cutting blade comprising:
a cutting blade body having first and second side surfaces and mounting apertures extending through first and second side surfaces,
a cutting edge support surface formed on the cutting blade body, the cutting edge support surface extending along an end surface of the cutting blade body transversely between the first and second surfaces;
a clad material build up comprising a plurality of layers including at least a first layer being deposited upon the cutting edge support surface and a second layer at least partially overlapping the first layer; and
a cutting edge provided by the clad material.

29. The cutting blade of claim 28, wherein the cutting edge support surface comprises first and second converging surfaces, the first converging surface extending from the first side surface at an oblique angle toward the second side surface, and the second converging surface extending from the second side surface at an oblique angle toward the first side surface, the first and second converging surfaces being joined by an end tip, wherein said clad material is built up along at least one of the converging surfaces.

30. The cutting blade of claim 29, wherein said clad material is built up along both of the converging surfaces and in partial overlap, and wherein a step in profile along the converging surfaces is defined and created by the built up second material along the converging surfaces to provide a thickened region proximate the cutting edge that is thicker in a cross section than the cutting edge support surface, the cross section in a plane extending through each of the side surfaces and perpendicular to the cutting edge.
